(19) United States
(12) Patent Application Publication
(10) Pub. No.: US 2024/0411081 A1
(43) Pub. Date: Dec. 12, 2024

(54) MULTICORE OPTICAL FIBER SYSTEM CONNECTIVITY IN DATA CENTERS

(71) Applicant: CORNING RESEARCH & DEVELOPMENT CORPORATION, Corning, NY (US)

(72) Inventors: Douglas Llewellyn Butler, Painted Post, NY (US); Kefeng Li, Painted Post, NY (US); Ming-Jun Li, Horseheads, NY (US); Pushkar Tandon, Painted Post, NY (US); Sergey Yurevich Ten, Ithaca, NY (US); Peter Gerard Wigley, Corning, NY (US)

(21) Appl. No.: 18/206,268

(22) Filed: Jun. 6, 2023

(51) Int. Cl. G02B 6/02; G02B 6/42; H04B 10/2581

(52) U.S. Cl. CPC G02B 6/02042; G02B 6/02395; G02B 6/4246; H04B 10/2581

(57) ABSTRACT

Systems and methods of configuring multicore optical fibers (30) to bidirectionally link optical transceivers (20). A bidirectional optical link (10) includes first and second optical transceivers (20), each including a transmitter optical port and a receiver optical port. The transmitter optical port of each optical transceiver (20) is operatively connected to the receiver optical port of the other optical transceiver (20) by a respective core (16) of a multicore optical fiber (30). The multicore optical fiber (30) is configured so that the optical signals propagating through the cores (16) of the multicore optical fiber (30) are travelling in opposite directions.

### TECHNICAL FIELD

This disclosure relates generally to optical connectivity, and more particularly to systems and methods of configuring multicore optical fibers to bidirectionally link optical transceivers.

### BACKGROUND

Optical fibers are useful in a wide variety of applications, the most common being as part of the physical layer of a communication protocol through which network nodes communicate over a data network. Benefits of optical fibers include wide bandwidth and low noise operation. Continued growth of the Internet has resulted in a corresponding increase in demand for network capacity. This demand for network capacity has, in turn, generated a need for increased bandwidth between network nodes.

Multicore optical fibers are optical fibers in which two or more cores are disposed within a common cladding. Multicore optical fibers function essentially as a bundle of single-core fibers, thereby providing increased capacity as compared to individual single-core optical fibers. The use of multicore optical fibers has yet to be widely adopted for long haul applications due to advances in technology that have enabled increased transmission rates over existing single-core optical fibers, such as dense wavelength division multiplexing and coherent optical communication techniques. Nevertheless, with the rapid growth of hyperscale datacenters, and the maturing of dense wavelength division multiplexing and coherent optical communication technologies, the use of multicore fiber optic cables is expected to increase. For example, a significant increase in the optical connections within data centers is being driven by artificial intelligence and machine learning cluster architectures. This has resulted in a five-to-tenfold increase in optical connections per unit wattage usage within data centers. This increase in optical connectivity density requires more efficient connectivity options to fit within the limited real estate available.

Thus, there is a need in the fiber optic industry for improved methods of using multicore optical fibers to provide fiber optic network links that facilitate a scalable infrastructure for higher bandwidth hardware connectivity. More particularly, there is a need for systems and methods of providing bidirectional optical links between optical transceivers.

### SUMMARY

In an aspect of the disclosure, a system for bidirectionally linking optical transceivers is disclosed. The system includes a first optical transceiver including a first transmitter optical port and a first receiver optical port, a second optical transceiver including a second transmitter optical port and a second receiver optical port, and a multicore optical fiber including a common cladding, a first core disposed in the common cladding, and a second core disposed in the common cladding. The first transmitter optical port is operatively coupled to the second receiver optical port by the first core of the multicore optical fiber, and the first receiver optical port is operatively coupled to the second transmitter optical port by the second core of the multicore optical fiber.

In an embodiment of the disclosed system, the first core and the second core of the multicore optical fiber may be arranged in a 1×2 configuration. In another embodiment of the disclosed system, each of the first core and the second core of the multicore optical fiber may have a step index core design. In another embodiment of the disclosed system, each of the first core and the second core of the multicore optical fiber may have a trench assisted core design. In another embodiment of the disclosed system, the inter-core distance between the first core and the second core of the multicore optical fiber may be between 35 μm and 45 μm.

In another embodiment of the disclosed system, the multicore optical fiber may further include a protective coating, the common cladding of the multicore optical fiber may have a diameter of less than 130 μm, and the protective coating of the multicore optical fiber may have a diameter of less than 210 μm. In another embodiment of the disclosed system, each of the first core and the second core of the multicore optical fiber may be configured to have a mode field diameter greater than 8.2 μm and less than 9.5 μm at 1310 nm, a cable cutoff wavelength of less than 1260 nm, and an inter-core separation distance sufficient to produce an inter-core crosstalk of less than −30 dB/km at 1550 nm and less than −78 dB/km at 1310 nm.

In another embodiment of the disclosed system, the multicore optical fiber may further include a third core and a fourth core each disposed in the common cladding, and the system may further include a third transceiver including a third transmitter optical port and a third receiver optical port and a fourth transceiver including a fourth transmitter optical port and a fourth receiver optical port. In this embodiment, the third transmitter optical port may be operatively coupled to the fourth receiver optical port by the third core of the multicore optical fiber, and the third receiver optical port may be operatively coupled to the fourth transmitter optical port by the fourth core of the multicore optical fiber.

In another embodiment of the disclosed system, each of the first core and the second core of the multicore optical fiber may have a core relative refractive index of less than 0.45%, a core radius of less than 5 μm, and a core alpha of greater than 5. In another embodiment of the disclosed system, each of the first core and the second core of the multicore optical fiber may have a core relative refractive index of greater than 0.3%, a core radius of larger than 4 μm, a core alpha of larger than 5, and the multicore optical fiber may further include a first inner cladding, a first trench region, and a common cladding region. The first inner cladding may encircle the first core, have a relative refractive index of between-0.05% and 0.05%, and have a radius between 8 μm and 12 μm. The first trench region may encircle the first inner cladding, have a relative refractive index of less than −0.25%, and have a radius between 12 μm and 20 μm. A common cladding may encircle the trench in which each of the core is disposed, have a relative refractive index of 0%.

In another aspect of the disclosure, a method of bidirectionally linking a plurality of optical transceivers including a first optical transceiver having a transmitter optical port and a receiver optical port, and a second optical transceiver having a transmitter optical port and a receiver optical port is disclosed. The method includes operatively coupling the transmitter optical port of the first optical transceiver to the first end of the first core of the multicore optical fiber, operatively coupling the receiver optical port of the second optical transceiver to the second end of the first core of the multicore optical fiber, operatively coupling the receiver optical port of the first optical transceiver to the first end of the second core of the multicore optical fiber, and operatively coupling the transmitter optical port of the second optical transceiver to the second end of the second core of the multicore optical fiber.

In an embodiment of the disclosed method, the first core and the second core of the multicore optical fiber may be arranged in the 1×2 configuration. In another embodiment of the disclosed method, each of the first core and the second core of the multicore optical fiber may be configured to have the step index core design. In another embodiment of the disclosed method, each of the first core and the second core of the multicore optical fiber may be configured to have the trench assisted core design. In another embodiment of the disclosed method, the inter-core distance between the first core and the second core of the multicore optical fiber may be configured to be between 35 μm and 45 μm.

In another embodiment of the disclosed method, the multicore optical fiber may further include a protective coating, the common cladding of the multicore optical fiber may have a diameter of less than 130 μm, and the protective coating of the multicore optical fiber may have a diameter of less than 210 μm. In another embodiment of the disclosed method, the method may further include configuring each of the first core and the second core of the multicore optical fiber to have a mode field diameter greater than 8.2 μm and less than 9.5 μm at 1310 nm, a cable cutoff wavelength of less than 1260 nm, and an inter-core separation distance sufficient to produce an inter-core crosstalk of less than −30 dB/km at 1550 nm and less than −78 dB/km at 1310 nm.

In another embodiment of the disclosed method, the plurality of optical transceivers may further include the third optical transceiver having the transmitter optical port and the receiver optical port, and the fourth optical transceiver having the transmitter optical port and the receiver optical port. In this embodiment, the method may further include operatively coupling the transmitter optical port of the third optical transceiver to a first end of the third core of the multicore optical fiber, operatively coupling the receiver optical port of the fourth optical transceiver to a second end of the third core of the multicore optical fiber, operatively coupling the receiver optical port of the third optical transceiver to a first end of the fourth core of the multicore optical fiber, and operatively coupling the transmitter optical port of the fourth optical transceiver to a second end of the fourth core of the multicore optical fiber.

In another embodiment of the disclosed method, the method may further include configuring each of the first core and the second core of the multicore optical fiber to have a core relative refractive index of less than 0.45%, a core radius of less than 5 μm, and a core alpha of greater than 5.

In another embodiment of the disclosed method, the method may further include configuring each of the first core and the second core of the multicore optical fiber to have a core relative refractive index of larger than 0.3%, a core radius of larger than 4 μm, a core alpha of larger than 5. In this embodiment, the method may further include configuring the multicore optical fiber to include the first inner cladding that encircles the first core, has a relative refractive index of between-0.05% and 0.05%, and has a radius of between 8 μm and 10 μm. The method may further include configuring the first trench region to encircle the first inner cladding, have a relative refractive index of less than −0.25%, and have a radius between 12 μm and 20 μm, and configuring the common cladding in which the cores are disposed to have a relative refractive index of 0%.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a schematic view of an exemplary bidirectional optical link that includes a single core optical fiber and a plurality of circulators.

FIG. 2 is a schematic view of another exemplary bidirectional optical link that includes a multicore optical fiber and lacks the circulators of the system of FIG. 1.

FIG. 3 is a cross-sectional schematic view of the multicore fiber optic cable of FIG. 2 having a step index core design.

FIG. 4 is a cross-sectional schematic view of an alternative embodiment of the multicore fiber optic cable of FIG. 2 having a trench assisted core design.

FIG. 5 is a schematic view of another exemplary system that includes a plurality of single core optical fibers operatively coupling a plurality of transceivers.

FIG. 6 is a schematic view of another exemplary bidirectional optical link that includes a plurality of multicore optical fibers operatively coupling the plurality of transceivers of FIG. 5.

FIG. 7 is a schematic view of another exemplary bidirectional optical link that includes a plurality of multicore optical fibers operatively coupling the plurality of transceivers of FIG. 5 in a cross-connected arrangement.

FIG. 8 is a schematic view of another exemplary bidirectional optical link that includes a plurality of optical fibers and circulators operatively coupling the plurality of transceivers of FIG. 5.

FIG. 9 is a graphical view including a plurality of plots of inter-core crosstalk versus inter-core distance for the multicore optical cables of FIGS. 2 and 6.

FIG. 10 is a perspective view of an exemplary transceiver including a circulator that may be used in the bidirectional optical link of FIG. 1.

FIG. 11 is a schematic view of the exemplary transceiver of FIG. 10.

FIG. 12 is a schematic view of another exemplary bidirectional optical link that includes a multicore optical fiber having four cores that operatively couple the plurality of transceivers of FIG. 5.

FIG. 13 is a cross-sectional schematic view of the multicore optical fiber of FIG. 12 showing the optical signals propagating through the cores thereof.

FIG. 14 is a schematic view of another exemplary bidirectional optical link including a plurality of transceivers operatively coupled by a plurality of the multicore optical fibers of FIG. 12.

FIG. 15 is a cross-sectional schematic view of the multicore optical fiber of FIG. 13 showing the optical signals of optical link of FIG. 14 propagating through the cores thereof.

FIGS. 16 and 17 are cross-sectional schematic views of alternative embodiments of multicore optical fibers that include a marker.

### DETAILED DESCRIPTION

Various embodiments will be further clarified by examples in the description below. The disclosed embodiments enable a scalable optical network infrastructure that increases bandwidth, reduces cost, and reduces energy consumption as compared to known solutions. The disclosed embodiments may also reduce and simplify connectivity of different components of the optical network, and may also enable circulators and fan-in/fan-out devices to be reduced in number or eliminated entirely.

Exemplary applications of multicore optical fiber based bidirectional optical links disclosed herein include an optical switch application. In this application, a multicore optical fiber is proposed that offers improved connectivity between optical switches and eliminates the need for optical circulators in the optical switches. Advantageously, eliminating optical circulators from the optical switches reduces both the cost and energy consumption of the optical switch. By way of example, optical switches connected by an 800 Gb/s optical link may each include an 800 Gb/s transceiver module having two 400 Gb/s transceiver units. Each 400 Gb/s transceiver unit may be operatively coupled to a corresponding 400 Gb/s transceiver unit of the second 800 Gb/s switch using a 1×2 multicore fiber or two cores of a four-core multicore fiber (e.g., with a 2×2 or 1×4 core arrangement). To enable this connectivity, multicore fibers may need to provide an inter-core crosstalk XT←30 dB/km within the 1550 nm wavelength window (e.g., at 1550 nm) and XT←78 dB/km within the 1310 nm wavelength window (e.g., at 1310 nm). In some embodiments, multicore fibers may need to provide an inter-core crosstalk XT←48 dB/km at 1550 nm and XT←78 dB/km at 1310 nm. The 1550 nm wavelength window is also known as C band, and covers a wavelength range from about 1530 to 1565 nm. The 1310 nm wavelength window is also known as O band, and covers a wavelength range from about 1260 to 1360 nm. Additional wavelength windows that may be referenced herein include E band (1360 to 1460 nm), S band (1460 to 1530 nm), L band (1565 to 1625 nm), and U band (1625 to 1675 nm).

Trench assisted core designs may be used in certain embodiments to meet the crosstalk specifications referred to above in a copropagating configuration. However, in other embodiments, the multicore optical fibers may be used in a counterpropagating configuration to allow the use of simple step index or graded index profiles. In some embodiments, the inter-core crosstalk is less than −48 dB/km at 1550 nm and less than −78 dB/km at 1310 nm. In some embodiments, the inter-core distance between the cores is between 30 and 50 μm. In some embodiments, the diameter of the common cladding of the multicore optical fibers may be less than 130 μm, and the diameter of the multicore optical fiber including a protective coating may be less than 210 μm, less than 190 μm, or less than 170 μm. In some embodiments, the protective coating may consist of two layers, a primary coating layer and a secondary coating layer. The primary coating layer may have a Young's modulus of less than 0.5 MPa, and a diameter of less than 170 μm. The secondary coating layer may have a Young's modulus of greater than 500 MPa, and a diameter of less than 210 μm. In some embodiments, the multicore optical fiber may be directly terminated with at least one physical contact connector. In some embodiments, the optical circuit switch or the 800 Gb/s transmission system may be operatively coupled to the multicore optical fiber without the use of fan-in and fan-out devices.

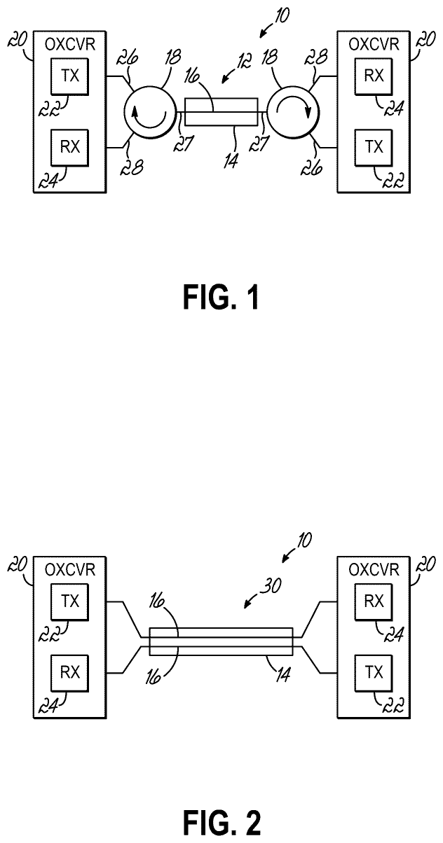

FIG. 1 depicts an exemplary bidirectional optical link 10 that includes an optical fiber 12 having a cladding 14 and a core 16, a plurality of optical circulators 18 (e.g., two optical circulators 18), and a plurality of optical transceivers 20 (e.g., two optical transceivers 20). The optical transceivers 20 may comprise a portion of an optical switch, for example. An optical switch is a multi-port network component that selectively connects optical fibers to each other. Optical switches may be configured to convert received optical signals into electrical signals for processing, then convert the processed electrical signals back into optical signals for retransmission. Other types of optical switches may be configured to receive, process, and retransmit optical signals without electrical conversion. It should be understood that the bidirectional optical links disclosed herein may be used with any type of optical switch, as well as to provide links between any other type of optical network components.

Each optical transceiver 20 may include a transmitter 22 configured to transmit an optical signal, and a receiver 24 configured to receive the optical signal. Each optical circulator 18 may include a plurality of optical ports 26-28 (e.g., three optical ports 26-28) arranged sequentially. One optical port 26 of each optical circulator 18 may be operatively coupled to the transmitter 22 of a respective optical transceiver 20, another optical port 27 may be operatively coupled to a respective end of the optical fiber 12, and another optical port 28 may be operatively coupled to the receiver 24 of the respective optical transceiver 20.

Each optical circulator 18 may be configured so that the optical ports 26-28 have cyclic connectivity. Cyclic connectivity refers to a characteristic in which an optical signal arriving at one optical port 26-28 of optical circulator 18 is operatively coupled to the next optical port 26-28 in the sequence of optical ports 26-28. For example, an optical signal transmitted from the transmitter 22 of optical transceiver 20 and received by optical port 26 of optical circulator 18 may be transmitted out of optical port 27 of the optical circulator 18. When this optical signal is received at optical port 27 of the optical circulator 18 at the other end of optical fiber 12, the optical signal may be transmitted from optical port 28 of the optical circulator 18 to the receiver 24 of optical transceiver 20. This cyclic connectivity of the optical circulators 18 may be provided by using birefringent crystals, magneto-optical Faraday rotators, polarizers, or any other suitable devices. Because optical signals travelling in opposite directions through the optical fiber 12 do not interact with each other, the use of optical circulators 18 may enable the optical transceivers 20 to have full duplex connectivity through an optical fiber 12 having a single core 16.

FIG. 2 depicts an alternative embodiment of the bidirectional optical link 10 that includes a multicore optical fiber 30 having multiple cores 16 (e.g., two cores 16) embedded in a single cladding 14, and a plurality of optical transceivers 20 (e.g., two optical transceivers 20). The multicore optical fiber 30 may be operatively coupled each optical transceiver 20 without use of fan-in and fan-out devices. The transmitter 22 of each optical transceiver 20 may be operatively coupled to the receiver 24 of the other transceiver 20 by a different core 16, thereby enabling the optical circulators 18 to be omitted. Omitting the optical circulators 18 may reduce power consumption and lower the cost of the bidirectional optical link 10.

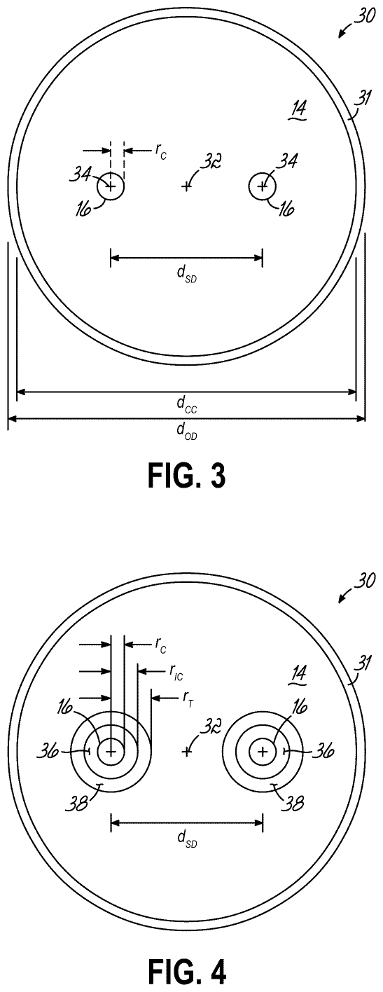

FIG. 3 depicts a cross-sectional view of an exemplary multicore optical fiber 30 including a common cladding 14 and a plurality of cores 16 (e.g., two cores 16) disposed in the common cladding 14. The multicore optical fiber 30 may also include a protective coating 31 that surrounds and protects the common cladding 14. The multicore optical fiber 30 may have an outer diameter d_{OD} defined by an outer surface of the protective coating 31. The common cladding 14 may have a diameter of d_{CC} and a fiber center axis 32. The cores 16 may be arranged equidistant from and colinearly with the fiber center axis 32. In an alternative embodiment, the cores 16 may be arranged so that they are not equidistant from the fiber center axis 32. Each core 16 may include a core center axis 34 and extend from core center axis 34 out to a core radius r_{C}. The cores 16 may be separated from each other by an inter-core separation distance d_{SD}. Each core may have an index of refraction n_{CORE} that differs from the index of refraction of the common cladding n_{CC} (e.g., n_{CORE}>n_{CC}) so that an optical signal propagating through the multicore optical fiber 30 is confined to a region around the core 16 into which the optical signal was transmitted.

A relative refractive index (A) of a material may be defined according to the equation:

$$Δ = \frac{{n}_{1}^{2} - {n}_{0}^{2}}{2 {n}_{1}^{2}} \qquad Eqn . 1$$

where n₁ is the index of refraction of the material in question (e.g., of the core material), and no is the index of refraction of a reference material (e.g., of the cladding material n₀=n_{CC}). Unless otherwise specified, the reference index of refraction no used herein to calculate the relative refractive index Δ of a material is 1.444, which is the index of refraction of undoped silica (a common cladding material) at a wavelength of 1550 nm. When the index of refraction n₁ of the material in question is less than the reference index of refraction no, the relative refractive index delta is negative. When the index of refraction of a region is greater than the reference index of refraction no, the relative refractive index delta is positive. The relative refractive index may also be expressed as a percentage (Δ%=100×Δ).

The relative refractive index of the core 16 may vary based on distance from the core center axis 34, and may be defined by a radially dependent profile function Δ(r) that includes an alpha parameter α as shown below,

$$Δ ( r ) = Δ ( {r}_{0} ) ( 1 - {[ \frac{\vert r - {r}_{0} \vert}{( {r}_{1} - {r}_{0} )} ]}^{α} ) \qquad Eqn . 2$$

where r₀ is the maximum radius from the core center axis 34 at which Δ(r) is at maximum (e.g., Δ(r₀)=Δ(0)), r₁ is the radius from the core center axis 34 at which Δ(r)=0, and α is the aforementioned alpha parameter. The profile function Δ(r) may be valid over the range r₀≤r≤r_{F}, where r_{F} is the final point of the profile function Δ(r).

The alpha parameter α of the cores 16 described herein may be in a range of 1≤α≤infinity. For α=1, the core has a triangular profile, for α=2, the core has a parabolic profile, and for α=infinity, the core has a perfect step profile. In practice, the relative refractive index of cores having an alpha profile may deviate from the ideal configuration as defined by the profile function Δ(r). Thus, the alpha parameter α for the core 16 of an optical fiber 12, 30 may be obtained from a best fit of a measured index profile. In cases where the alpha parameter α<10, the core 16 may generally be referred to as a graded index core. In cases where the alpha parameter α>10, the core 16 may generally be referred to as a step index core.

Optical signals propagating through a single mode optical fiber propagate in a single fundamental linear polarization mode (or “LP mode”) referred to as the LP₀₁ mode. Single mode optical fibers have what is referred to as a cutoff wavelength. Optical signals having a wavelength that is less than the cutoff wavelength propagate in multiple modes, e.g., LP₀₁ and LP₁₁. Thus, at wavelengths of light below the cutoff wavelength, a single mode optical fiber becomes a multimode optical fiber. The theoretical cutoff wavelength λ_{C} of an optical fiber in which the core has a higher index of refraction than the cladding (i.e., n_{core}>N_{cladding}) may be approximated by:

$${λ}_{c} = 2 π \times {r}_{c} \times \frac{\sqrt{{n}_{c o r e}^{2} - {n}_{cladding}^{2}}}{{V}_{c}} \qquad Eqn . 3$$

where V_{c} is the normalized cutoff frequency, which depends on the alpha parameter or profile shape. For α=1, V_{c}=4.381, for α=2, V_{c}=3.518, and for α=infinity, V_{c}=2.405. In a practical fiber, the cutoff wavelength depends on LP₁₁ mode attenuation, which changes with the deployment conditions. A “cable cutoff wavelength” or “cable cutoff” for an optical fiber may be defined by a 22 meter cable cutoff test as specified by the International Electrotechnical Commission (IEC) standard 60793-1-44, entitled “Measurement methods and test procedures—Cut-off wavelength.”

An optical signal propagating through a single mode optical fiber has a cross sectional intensity profile that typically extends beyond the core 16 (e.g., into the common cladding 14) such that the mode field diameter of the optical signal is greater than the diameter of the core 16. The “mode field diameter” or “MFD” of an optical fiber may be defined as:

$$MFD = 2 w \qquad Eqn . 4$$

$$where :$$

$${w}^{2} = 2 \frac{{\int }_{0}^{∞} {( f ( r ) )}^{2} r d r}{{\int }_{0}^{∞} Idr}$$

f(r) is the transverse component of the electric field distribution of the guided optical signal, and r is radial position in the fiber. The mode field diameter of an optical fiber depends on the wavelength of the optical signal, and may be reported herein at one or more wavelengths, e.g., at 1310 nm, 1550 nm, and 1625 nm. Specific indication of the wavelength may be made when referring to mode field diameter herein. Unless otherwise specified, the mode field diameter refers to the LP₀₁ mode at the specified wavelength.

FIG. 4 depicts an alternative embodiment of the multicore optical fiber 30 in which the cores 16 have what is referred to as a trench assisted core design. A multicore optical fiber 30 having a trench assisted core design further includes an inner cladding region 36 that encircles the core 16 and extends from radius f_{C} to r_{IC}, and a trench region 38 that extends from radius r_{IC} to r_{T}. The core 16 may have an enhanced relative refractive index Δ_{C} greater than silica, e.g., Δ_{C}>0. The inner cladding region 36 may have a relative refractive index Δ_{IC} close to that of silica, e.g., Δ_{IC.}≈0. The trench region 38 may have a depressed relative refractive index Δ_{T} that is less than silica, e.g., Δ_{T}<0.

The common cladding 14 and inner cladding region 36 may be formed from a silica-based glass that is substantially free of dopants, the core 16 may be formed from a silica-based glass that includes one or more up-dopants, and the trench region 38 may be formed from a silica-based glass that includes one or more down-dopants. An up-dopant is a substance that tends to increase the index of refraction of undoped silica glass. A down-dopant is a substance that tends to decrease the index of refraction of undoped silica glass. Exemplary up-dopants include germania (GeO₂), aluminum oxide (Al₂O₃), phosphorous pentoxide (P₂O₅), titanium dioxide (TiO₂), chlorine (Cl), bromine (Br), and alkali metal oxides, such as potassium oxide (K₂O), sodium oxide (Na₂O), lithium oxide (Li₂O), cesium oxide (Cs₂O), rubidium oxide (Rb₂O), and combinations thereof. Exemplary down-dopants include fluorine (F) and boron oxide (B₂O₃).

Optical signals propagating along a core 16 surrounded by a trench region 38 as depicted in FIG. 4 tend to be more tightly confined than optical signals propagating along a core 16 that directly contacts the common cladding 14 as depicted in FIG. 3. This tighter confinement may result in a smaller mode field diameter and lower crosstalk between the cores 16 of multicore optical fibers 30.

Crosstalk in a multicore optical fiber 30 refers to the (typically undesirable) coupling of optical signals between cores 16. In multicore optical fibers 30 having more than two cores 16, crosstalk is typically strongest between adjacent cores 16. Crosstalk between two cores 16 may be determined theoretically based on their coupling coefficient. The coupling coefficient depends on the design of the cores 16, the distance between the cores 16, and the structure of the cladding surrounding the cores 16. The crosstalk also depends on the mismatch Δβ between the propagation constants β of the cores 16, bending radius under which the optical fiber is deployed, and the length of the multicore optical fiber 30. Crosstalk XT can be defined as,

$$XT = 10 \times {log}_{10} ( \frac{{P}^{′}}{P} ) dB \qquad Eqn . 5$$

where P is the power of the optical signal in the illuminated core 16 at the receiving end of the multicore optical fiber 30, and P′ is the power of the crosstalk signal in the unilluminated core 16 at the receiving end of the multicore optical fiber 30. For a transmission system, the crosstalk should be below −30 dB to ensure acceptable system performance, preferably below −40 dB, and even more preferably below −50 dB.

The crosstalk between the two adjacent core portions increases linearly with fiber length in the linear scale but does not increase linearly with fiber length in the dB scale. Crosstalk performance may be referenced to a length of optical fiber, e.g., 100 km. However, crosstalk performance can also be represented with respect to alternative optical fiber lengths, with appropriate scaling. For optical fiber lengths other than 100 km, the crosstalk between core portions can be determined using the following equation:

$$XT ( L ) = XT ( 100 ) + 10 log ( \frac{L}{100} ) \qquad Eqn . 6$$

By way of example, for a 10 km length of optical fiber, the crosstalk can be determined by adding “−10 dB” to the crosstalk value for a 100 km length optical fiber. For a 1 km length of optical fiber, the crosstalk can be determined by adding “−20 dB” to the crosstalk value for a 100 km length of optical fiber.

Techniques for determining cross talk between cores in a multicore optical fiber can be found in M. Li, et al., “Coupled Mode Analysis of Crosstalk in Multicore fiber with Random Perturbations,” Optical Fiber Communication Conference, OSA Technical Digest (online), Optical Society of America, 2015, paper W2A.35, in Shoichiro Matsuo, et al., “Crosstalk behavior of cores in multi-core portion under bent condition,” IEICE Electronics Express, Vol. 8, No. 6, p. 385-390, published Mar. 25, 2011, and in Lukasz Szostkiewicz, et al., “Cross talk analysis in multicore optical fibers by supermode theory,” Optics Letters, Vol. 41, No. 16, p. 3759-3762, published Aug. 15, 2016, which are all incorporated by reference herein in their entireties. Techniques for determining co-propagating and counter-propagating cross talk between cores in a multicore optical fiber can be found in Akihide Sano et al., “Crosstalk-Managed High Capacity Long Haul Multicore Fiber Transmission With Propagation-Direction Interleaving,” Journal of Lightwave Technology, Vol. 32, No. 16, p. 2771-2779, published Aug. 15, 2014, and in Tetsuya Hayashi et al., “Uncoupled Multi-Core Fiber Design for Practical Bidirectional Optical Communications,” OFC, Optica Publishing Group, 2022, which are also incorporated by reference herein in their entireties.

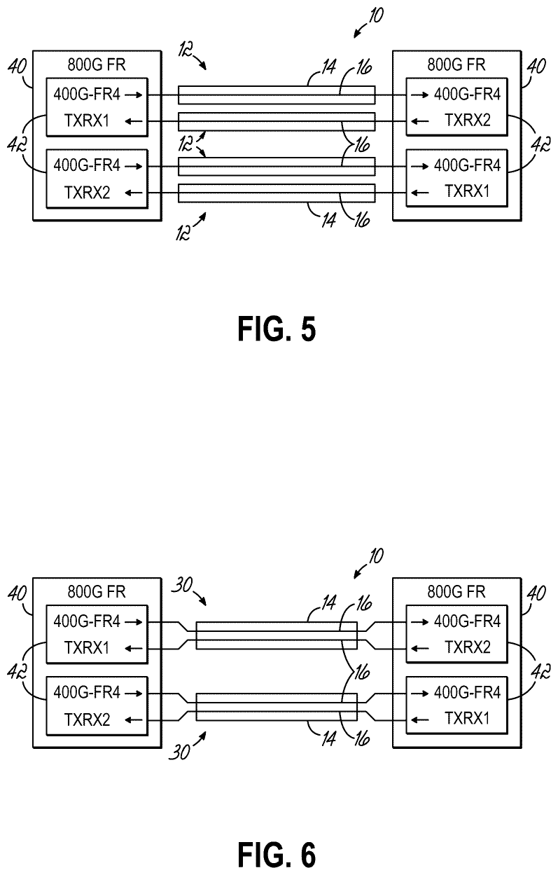

FIG. 5 depicts an exemplary bidirectional optical link 10 that uses four single core fibers 12 to support an 800G FR transmission system. In the depicted embodiment, each 800G module 40 includes two 400G units 42. Each 400G unit 42 in one of the 800G modules is operatively coupled to a respective 400G unit 42 in the other 800G module 40 using two single core optical fibers 12. Thus, each single core fiber 12 operatively couples the transmitter of one of the 400G units to the receiver of the other 400G unit. This configuration avoids the need to include an optical circulator 18 in the 800G modules 40.

FIG. 6 depicts another exemplary bidirectional optical link 10 that uses two 1×2 multicore optical fibers 30 to support an 800G FR transmission system. In this embodiment, each 800G module 40 also includes two 400G units 42. However, each 400G unit 42 in one of the 800G modules 40 is operatively coupled to a respective 400G unit 42 in the other 800G module 40 using a single 1×2 multicore optical fiber 30. Thus, one core 16 of each multicore optical fiber 30 operatively couples the transmitter of one 400G unit 42 to the receiver of another 400G unit 42, and the other core 16 operatively couples the receiver of the one 400G unit 42 to the transmitter of the other 400G unit 42. Accordingly, each multicore optical fiber 30 has optical signals propagating in opposite directions (a different direction for each core 16). Optical signals propagating in opposite directions within an optical fiber (in either a single core 16 or separate cores 16) are referred to herein as counterpropagating optical signals. In contrast, optical signals propagating in the same direction within an optical fiber (in either a single core 16 or separate cores 16) are referred to as copropagating optical signals. The configuration depicted by FIG. 6 also avoids use of an optical circulator 18 in the 800G modules 40. The multicore optical fiber 30 may be operatively coupled each optical transceiver 40 without use of fan-in and fan-out devices.

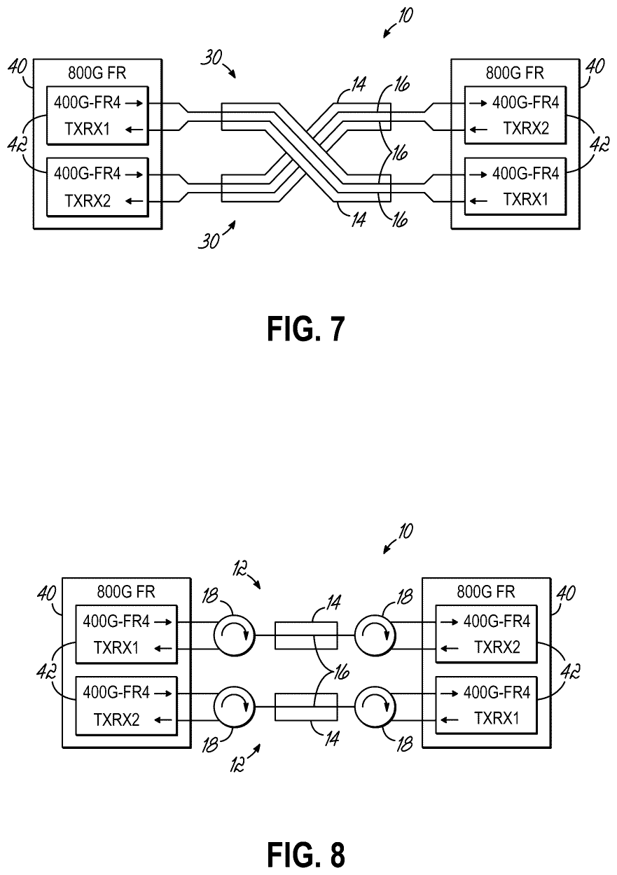

FIG. 7 depicts another exemplary bidirectional optical link 10 that uses two 1×2 multicore optical fibers 30 to support an 800G FR transmission system. This embodiment is similar to that depicted by FIG. 6, except that each multicore optical fiber 30 operatively couples the transmitter of one 400G unit 42 to the receiver of another 400G unit 42 in a cross-connected arrangement. This embodiment may be appropriate for a Type B or Type C polarity connection. In comparison, the bidirectional optical link 10 of FIG. 6 may be more appropriate for a Type A polarity connection.

FIG. 8 depicts an exemplary bidirectional optical link 10 that uses two single core fibers 12 to support the 800G FR transmission system of FIG. 5. A circulator 18 manages the forward and reverse optical signals at each 400G unit 42 so that each 400G unit 42 in one of the 800G modules is operatively coupled to a respective 400G unit 42 in the other 800G module 40 using one single core optical fiber 12.

Table I provides specifications for exemplary multicore optical fibers 30 having cores 16 with trench assisted and step index core designs for use in 1×2 multicore optical fibers.

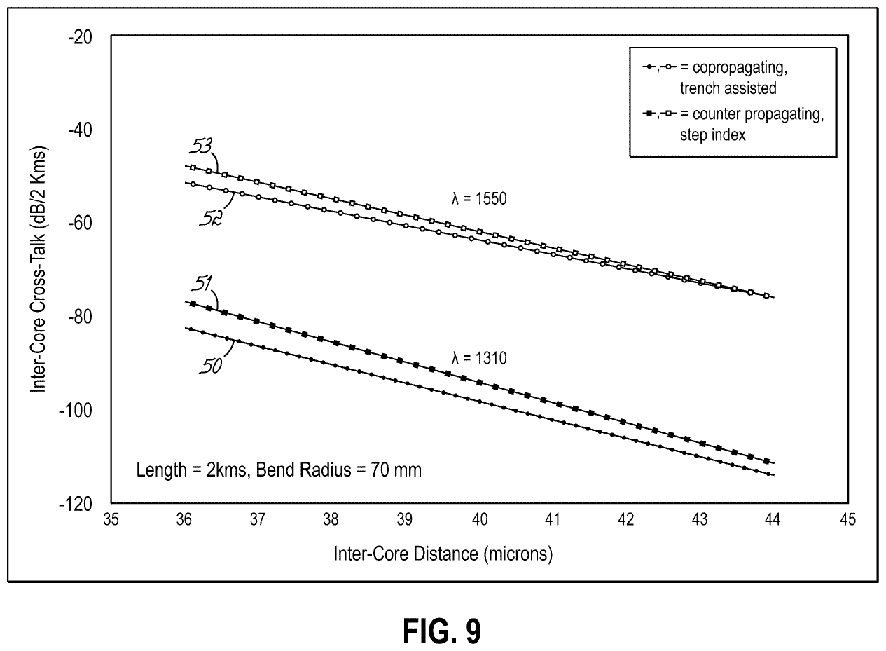

FIG. 9 depicts a graph including plots 50-53 of inter-core crosstalk versus inter-core separation distance d_{SD} for various multicore optical fiber configurations. As can be seen by comparing the plots 50-53, a multicore optical fiber 30 having step index cores 16 operating in a counter-propagating transmission configuration has comparable crosstalk performance to a multicore optical fiber 30 having a trench assisted core 16 in a copropagating configuration.

TABLE I

| Parameter | Trench Assisted | Step Index |
|---|---|---|
| Core Relative Refractive Index Δ_{C} (%) | 0.36 | 0.39 |
| Core Radius r_{C} (μm) | 4.1 | 4.35 |
| Core Alpha α | 12 | 12 |
| Inner Cladding Relative Refractive | 0 | N/A |
| Index Δ_{IC} (%) | | |
| Inner Cladding Radius r_{IC} (μm) | 10 | N/A |
| Trench Relative Refractive Index Δ_{T} (%) | −0.39 | N/A |
| Trench Radius r_{T} (μm) | 16.7 | N/A |
| Common Cladding Diameter d_{CC} (μm) | 125 | 125 |
| Multicore Design | 1 × 2 | 1 × 2 |
| MFD at 1310 nm (μm) | 8.65 | 8.61 |
| MFD at 1550 nm (μm) | 9.80 | 9.76 |
| Effective Area at 1310 nm (μm²) | 58.12 | 58.48 |
| Effective Area at 1550 nm (μm²) | 73.14 | 72.96 |
| Cable Cutoff Wavelength (nm) | <1260 nm | <1260 nm |

Plot 50 shows the crosstalk for a 2 km length of multicore optical fiber 30 having the specifications of the trench assisted core design of Table I with copropagating optical signals having a wavelength A=1310 nm. Plot 51 shows the crosstalk for a 2 km length of multicore optical fiber 30 having the specifications of the step index core design of Table I with counterpropagating optical signals having a wavelength A=1310 nm. As can be seen, the use of a counterpropagating configuration enables multicore optical fibers 30 having a step index core design to have a crosstalk performance within about 5 dB of the crosstalk performance of 2 km multicore optical fibers 30 having the more expensive trench assisted core design but used in a copropagating configuration at a wavelength A=1310 nm. The crosstalk shown Plots 50 and 51 at 1310 nm for 2 km fiber is below about −48 dB, or −51 dB/km, which is well suited for FR transceivers specified for 2 km transmission. The fibers can also be used for transceivers specified for longer distance transmission at 1310 nm such as LR and DR for 10 km.

Plot 52 shows crosstalk for the 2 km length of multicore optical fiber 30 having the specifications of the trench assisted core design of Table I with copropagating optical signals having a wavelength A=1550 nm. Plot 53 shows the crosstalk for the 2 km length of multicore optical fiber 30 having the specifications of the step index core design of Table I with counterpropagating optical signals having a wavelength A=1550 nm. At this wavelength, the use of a counterpropagating configuration enables multicore optical fibers 30 having a step index core design to have a crosstalk performance within about 3.4 dB of the crosstalk performance of 2 km multicore optical fibers 30 having the more expensive trench assisted core design but used in a copropagating configuration. The crosstalk shown by plots 52 and 53 at 1550 nm for 2 km fiber is below about −78 dB, or −81 dB/km, which is well suited for FR transceivers specified for 2 km transmission. The fibers can also be used for transceivers specified for longer distance transmission at 1550 nm such as LR and DR for 10 km, and ZR for 100 km.

Some of the exemplary bidirectional optical links 10 disclosed herein included 1×2 multicore optical fibers 30 configured in a manner that makes optical circulators 18 unnecessary. These embodiments may be particularly suited for operatively coupling optical transceivers 20 in which the transmitter 22 and receiver 24 are adjacent to each other and contained within the same pluggable optical transceiver 20. However, for embodiments that include optical transceivers 20 with an integrated optical circulator 18, it may be advantageous to use alternative multicore optical fiber configurations.

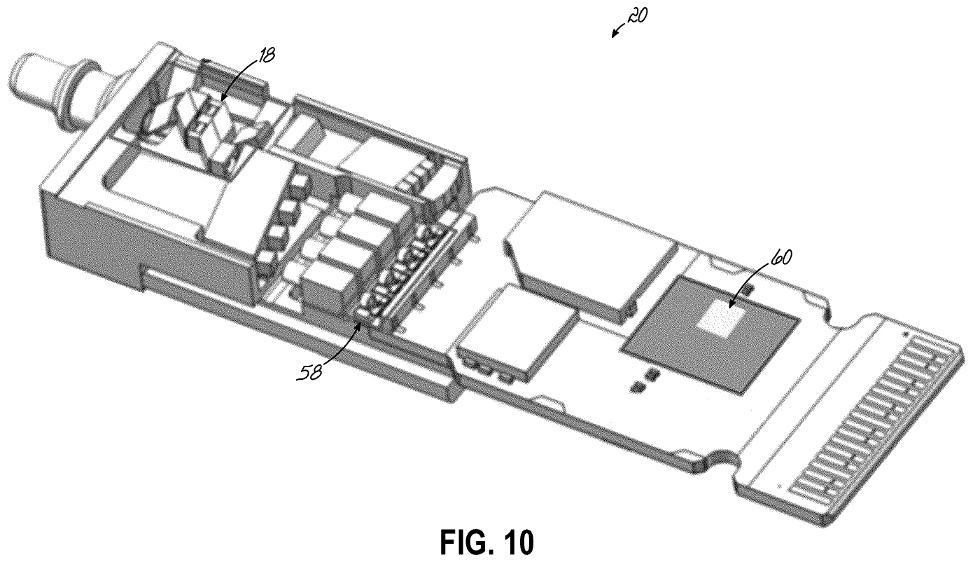

FIG. 10 depicts an exemplary optical transceiver 20 that includes an integrated optical circulator 18, a laser module 58 (e.g., electro-absorption modulated or directly modulated laser diodes), and a processor 60 (e.g., a digital signal processor configured to provide clock and data recovery). The integrated optical circulator 18 may be configured to separate and combine transmitted and received optical signals copropagating through one or more cores 16 of a single core optical fiber 12 or multicore optical fiber 30. This type of optical transceiver 20 is commonly available as a commercialized product from multiple vendors, and thus may be encountered in a datacenter. This type of optical transceiver 20 may also be used advantageously with multicore optical fibers 30.

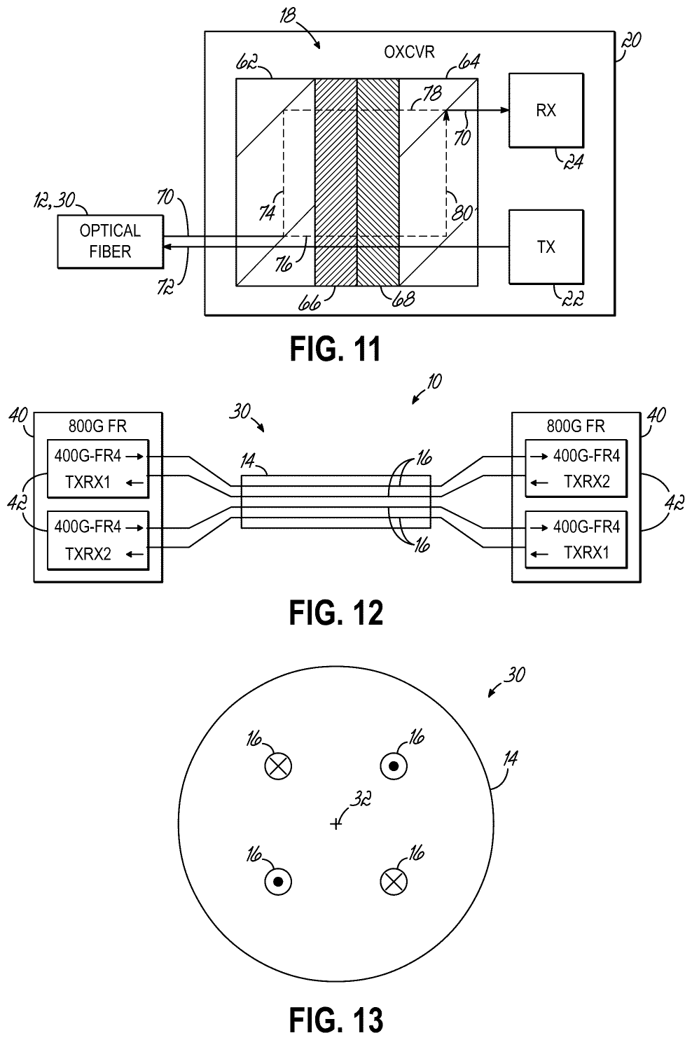

FIG. 11 depicts an exemplary optical transceiver 20 including an integrated optical circulator 18 that has a fiber side polarizing beam splitter 62, a transceiver side polarizing beam splitter 64, a half wave plate 66, and a Faraday rotator 68. The Faraday rotator 68 may be self-magnetized or receive a magnetic field from an external source (not shown). The polarization beam splitters 62, 64, half wave plate 66, and Faraday rotator 68 may operate cooperatively to separate spatially coincident counterpropagating optical signals 70, 72 propagating through an optical fiber 12, 30 into a pair of spatially separated counterpropagating optical signals 70, 72.

The fiber side polarizing beam splitter 62 may be configured to split the incoming optical signal 70 into a reflected s-polarized component 74 and a transmitted p-polarized component 76. These polarized components 74, 76 may be rotated by 90 degrees as they pass through the half wave plate 66 and Faraday rotator 68. As a result of this rotation, the s-polarized component 74 may emerge from the Faraday rotator 68 as a p-polarized component 78, and p-polarized component 76 may emerge from the Faraday rotator as an s-polarized component 80. The transceiver side polarizing beam splitter 64 may reflect the polarized components 78, 80 according to their rotated polarization, thereby recombining the polarized components 78, 80 to reconstruct the incoming optical signal 70. The reconstructed optical signal 70 may then be operatively coupled to the receiver 24 of optical transceiver 20. The outgoing optical signal 72 transmitted from the transmitter 22 of optical transceiver 20 may pass through the polarizing beam splitters 62, 64 owing to its direction of propagation, and be operatively coupled into the optical fiber 12, 30.

The component count of the optical circulator 18 of FIG. 11 may be half that of a fully polarization independent optical circulator 18 due to it having a fixed polarization orientation relative to the laser of transmitter 22. By integrating the optical circulator 18 into the optical transceiver 20, the spatially coincident counterpropagating optical signals 70, 72 in the optical fiber 12, 30 are spatially separated into a forward propagating signal that is routed to the receiver 24, and the backward propagating optical signal 72 which is routed from the transmitter 22. The layout of the optical circulator 18 depicted by FIG. 11 may be typical, but it should be understood that alternative optical circulators 18 may be used. For example, the optical circulator 18 may use polarization beam displacers as an alternative to the polarizing beam splitters 62, 64, to provide a similar net functionality.

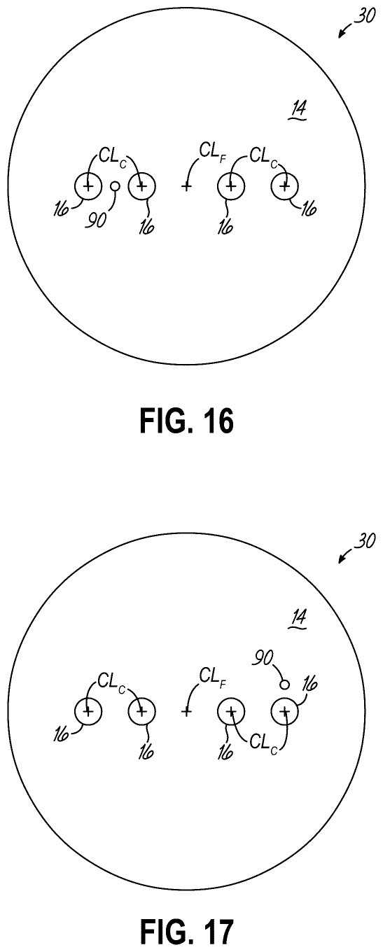

FIG. 12 depicts another exemplary bidirectional optical link 10 that uses one 2×2 multicore optical fiber 30 to support an 800G FR transmission system including two 800G modules 40 each having two 400G units 42. FIG. 13 depicts a cross-sectional view of an exemplary 2×2 multicore optical fiber 30 that may be used in the system of FIG. 12. As best shown by FIG. 13, the multicore optical fiber 30 includes four cores 16 disposed within the common cladding 14 and spaced symmetrically around the fiber center axis 32 of multicore optical fiber 30. FIG. 13 depicts the multicore optical fiber 30 with an exemplary arrangement of forward and reverse optical signals, with the optical signals propagating away from the viewer being indicated by an X, and optical signals propagating toward the viewer being indicated by a dot. Alternatively, and as will be described in greater detail below with reference to FIGS. 16 and 17, the four cores 16 may be arranged in a 1×4 linear array configuration. The linear array configuration may be coupled directly to a transceiver with a linear configuration of optical transmitters and receivers.

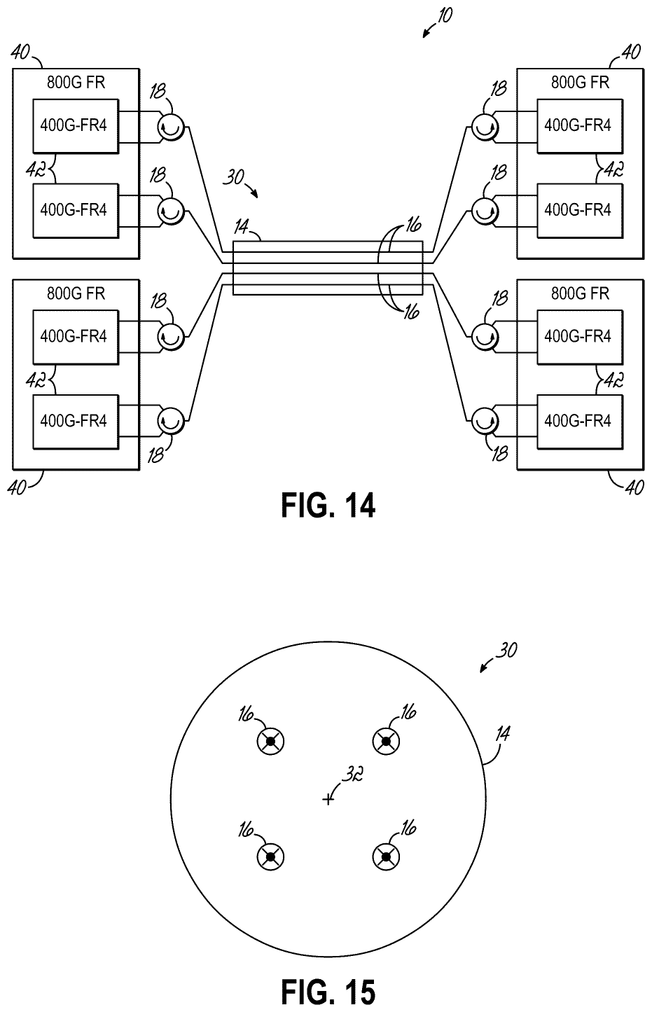

FIG. 14 depicts another exemplary bidirectional optical link 10 that uses one 2×2 multicore optical fiber 30 to support an 800G FR transmission system including two 800G modules 40 each having two 400G units 42. In this embodiment, each 400G unit 42 includes an optical circulator 18. FIG. 15 depicts a cross-sectional view of an exemplary 2×2 multicore optical fiber 30 that may be used in the system of FIG. 14. As best shown by FIG. 15, the multicore optical fiber 30 includes four cores 16 disposed within the common cladding 14 and spaced symmetrically around the fiber center axis 32 of multicore optical fiber 30. FIG. 15 depicts the multicore optical fiber 30 showing copropagating forward and reverse optical signals in each core 16 of multicore optical fiber 30, i.e., as an X overlayed by a dot. By enabling copropagating optical signals in each core 16, the optical circulator 18 allows two 800G modules 40 at one location to be operatively coupled to another two 800G modules 40 at another location by a single 2×2 multicore optical fiber 30. This may further simplify the bidirectional optical link 10 and double the capacity of the link per multicore optical fiber 30 as compared to bidirectional optical links that lack optical circulators 18.

Other core arrangements are possible according to this disclosure. Additionally, marker cores may also be included in the core arrangements, including those already discussed (e.g., 1×2 and 2×2 core arrangements) as well as in other core arrangements that may be used. To this end, FIGS. 16 and 17 illustrate examples of an alternative core arrangement for the multicore optical fiber 30 used in the bidirectional links shown in FIGS. 12 and 14.

As shown in FIG. 16, a marker 90 may be disposed in the cladding 14 of multicore optical fiber 30 to mark, for example, one or two cores 16. For example, marker 90 may be used to identify the relative location of a “reference core” within optical fiber 30. The other cores may then be identified based upon their position relative to the reference core. Therefore, in embodiments, marker 90 is disposed in cladding 14 at a position to clearly identify the reference core. It is noted that a first end of an optical fiber is a mirror image of the second end of the optical fiber. Thus, placing marker 90 at a centerline of the optical fiber may not be useful to distinguish between the different cores. More specifically, with reference to FIG. 16, placing maker 90 at a centerline of optical fiber 10 between the center two cores is not useful to distinguish between these two cores, as the core in the middle-right position is in the middle-left position at the opposite end of the fiber. Therefore, in embodiments, marker 90 is not disposed at the centerline CL_{F} of optical fiber 30.

In the embodiment of FIG. 16, marker 90 is disposed equidistantly between the centerlines CL_{C} of two adjacent cores 16 such that at least one of these adjacent cores is an outer core. Therefore, in this embodiment, the outer core near marker 90 may be identified as the reference core. However, it is also contemplated that marker 90 may be disposed in other locations within cladding 14 with preference given to locations that are not on a line of symmetry of the fiber so as to uniquely identify a core regardless of which mirror image end of the fiber is being viewed. For example, as shown in FIG. 17, marker 90 is disposed closest to a particular core 16 to mark that particular core as the reference core. It is noted that marker 90 in FIG. 16 and in FIG. 17 is not located on a line of symmetry of the optical fiber 30. Marker 90 can comprise doped silica glass such that marker 90 has a relative refractive index that is not equivalent to the relative refractive index of cladding 14 (Δₘₐᵣₖₑᵣ≠Δ_{cladding}). In some embodiments, the silica glass of marker 90 is doped with a down-dopant such that marker 90 forms a trench region in cladding 14. In other embodiments, marker 90 is up-doped with, for example, germanium.

In other embodiments, the core arrangement may be non-symmetrical about the centerline CL_{F} of the optical fiber 30 and/or include one core at a different distance from the centerline CL_{F} of the optical fiber 30. Such arrangements may allow the relative location of a reference core within optical fiber 30 to be identified such that marker cores are not needed.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The present disclosure in its broader aspects is therefore not limited to the specific details, representative apparatus, and methods and illustrative examples shown and described. Accordingly, departures may be made from such details without departing from the scope of the present disclosure.

1. A system for bidirectionally linking optical transceivers, comprising:
a first optical transceiver including a first transmitter optical port and a first receiver optical port;
a second optical transceiver including a second transmitter optical port and a second receiver optical port; and
a multicore optical fiber including a common cladding, a first core disposed in the common cladding, and a second core disposed in the common cladding, wherein,
the first transmitter optical port is operatively coupled to the second receiver optical port by the first core of the multicore optical fiber, and
the first receiver optical port is operatively coupled to the second transmitter optical port by the second core of the multicore optical fiber.

2. The system of claim 1, wherein the first core and the second core of the multicore optical fiber are arranged in a 1×2 configuration.

3. The system of claim 1, wherein each of the first core and the second core of the multicore optical fiber has a step index core design.

4. The system of claim 1, wherein each of the first core and the second core of the multicore optical fiber have a trench assisted core design.

5. The system of claim 1, wherein an inter-core distance between the first core and the second core of the multicore optical fiber is between 35 μm and 45 μm.

6. The system of claim 1, wherein the multicore optical fiber further includes a protective coating, the common cladding of the multicore optical fiber has a diameter of less than 130 μm, and the protective coating of the multicore optical fiber has a diameter of less than 210 μm.

7. The system of claim 1, wherein each of the first core and the second core of the multicore optical fiber are configured to have a mode field diameter greater than 8.2 μm at 1310 nm, a cable cutoff wavelength of less than 1260 nm, and an inter-core separation distance sufficient to produce an inter-core counter-propagating crosstalk of less than −30 dB/km in a 1310 nm wavelength window and a 1550 nm wavelength window.

8. The system of claim 7, wherein each of the first core and the second core of the multicore optical fiber are configured to have an inter-core counter-propagating crosstalk of less than −48 dB/km at 1550 nm and less than −78 dB/km at 1310 nm.

9. The system of claim 1, wherein the multicore optical fiber further includes a third core and a fourth core each disposed in the common cladding, and further comprising:
a third transceiver including a third transmitter optical port and a third receiver optical port; and
a fourth transceiver including a fourth transmitter optical port and a fourth receiver optical port, wherein,
the third transmitter optical port is operatively coupled to the fourth receiver optical port by the third core of the multicore optical fiber, and
the third receiver optical port is operatively coupled to the fourth transmitter optical port by the fourth core of the multicore optical fiber.

10. The system of claim 1, wherein each of the first core and the second core of the multicore optical fiber has a core relative refractive index of less than 0.45%, a core radius of less than 5 μm, and a core alpha of greater than 5.

11. The system of claim 10, wherein each of the first core and the second core of the multicore optical fiber has a core alpha greater than 5 and equal to or less than 12.

12. The system of claim 1, wherein each of the first core and the second core of the multicore optical fiber has a core relative refractive index of less than 0.4%, a core radius larger than 4 μm, a core alpha of greater than 5, and the multicore optical fiber further includes:
a first inner cladding and a second inner cladding that respectively encircle the first core and the second core, and that each have a relative refractive index of 0% and a radius between 8 μm and 12 μm; and
a first trench region and a second trench region that respectively encircle the first inner cladding and the second inner cladding, and that each have a relative refractive index of less than −0.2% and a radius between 12 μm and 20 μm;
wherein the common cladding surrounds the first trench region and the second trench region.

13. A method of bidirectionally linking a plurality of optical transceivers including a first optical transceiver having a first transmitter optical port and a first receiver optical port, and a second optical transceiver having a second transmitter optical port and a second receiver optical port, comprising:
operatively coupling the first transmitter optical port of the first optical transceiver to a first end of a first core of a multicore optical fiber;
operatively coupling the second receiver optical port of the second optical transceiver to a second end of the first core of the multicore optical fiber;
operatively coupling the first receiver optical port of the first optical transceiver to a first end of a second core of the multicore optical fiber; and
operatively coupling the second transmitter optical port of the second optical transceiver to a second end of the second core of the multicore optical fiber.

14. The method of claim 13, wherein the first core and the second core of the multicore optical fiber are arranged in a 1×2 configuration.

15. The method of claim 13, wherein each of the first core and the second core of the multicore optical fiber has a step index core design.

16. The method of claim 13, wherein each of the first core and the second core of the multicore optical fiber has a trench assisted core design.

17. The method of claim 13, wherein;
inter-core distance between the first core and the second core of the multicore optical fiber is between 35 μm and 45 μm,
the multicore optical fiber further includes a protective coating,
the common cladding of the multicore optical fiber has a diameter of less than 130 μm, and the protective coating of the multicore optical fiber has a diameter of less than 210 μm.

18. (canceled)

19. The method of claim 17, further comprising:
configuring each of the first core and the second core of the multicore optical fiber to have a mode field diameter greater than 8.2 μm at 1310 nm, a cable cutoff wavelength of less than 1260 nm, and an inter-core separation distance sufficient to produce an inter-core crosstalk of less than −30 dB/km in a 1310 nm wavelength window and a 1550 nm wavelength window.

20. The method of claim 13, wherein the plurality of optical transceivers further includes a third optical transceiver having a third transmitter optical port and a third receiver optical port, and a fourth optical transceiver having a fourth transmitter optical port and a fourth receiver optical port, and further comprising:
operatively coupling the third transmitter optical port of the third optical transceiver to a first end of a third core of the multicore optical fiber;
operatively coupling the fourth receiver optical port of the fourth optical transceiver to a second end of the third core of the multicore optical fiber;
operatively coupling the third receiver optical port of the third optical transceiver to a first end of a fourth core of the multicore optical fiber; and
operatively coupling the fourth transmitter optical port of the fourth optical transceiver to a second end of the fourth core of the multicore optical fiber.

21-28. (canceled)

29. A system for bidirectionally linking optical transceivers, comprising:
a first optical transceiver including a first transmitter optical port and a first receiver optical port;
a second optical transceiver including a second transmitter optical port and a second receiver optical port; and
a multicore optical fiber including a common cladding, a first core disposed in the common cladding, and a second core disposed in the common cladding,
wherein:
the first transmitter optical port is operatively coupled to the second receiver optical port by the first core of the multicore optical fiber, and
the first receiver optical port is operatively coupled to the second transmitter optical port by the second core of the multicore optical fiber, and
further wherein:
an inter-core distance between the first core and the second core of the multicore optical fiber is between 35 μm and 45 μm the multicore optical fiber further includes a protective coating,
the common cladding of the multicore optical fiber has a diameter of less than 130 μm, and
the protective coating of the multicore optical fiber has a diameter of less than 210 μm.
